(19) United States
(12) Patent Application Publication
(10) Pub. No.: US 2010/0238103 A1
(43) Pub. Date: Sep. 23, 2010

(54) Method to Obtain Uniform Grayscale to Grayscale Response Times in LCDs and a System Thereof

(75) Inventor: T. N. Ruckmongathan, Bangalore (IN)

Correspondence Address: FENWICK & WEST LLP, SILICON VALLEY CENTER, 801 CALIFORNIA STREET, MOUNTAIN VIEW, CA, 94041, US

(73) Assignee: RAMAN RESEARCH INSTITUTE, Bangalore (IN)

(21) Appl. No.: 12/435,331

(22) Filed: May 4, 2009

(30) Foreign Application Priority Data
Mar. 20, 2009 (IN) 00636/CHE/2009

(51) Int. Cl. G09G 3/36

(52) U.S. Cl. 345/89

(57) ABSTRACT

Despite rapid advances in science and technology of liquid crystal display (LCD); elimination of motion related artifacts and preservation of color purity in moving images have remained elusive because gray-scale to gray-scale response time, i.e., time taken to switch pixels from one gray-scale to another depends on the initial and final gray shades. A technique wherein gray scale to gray scale response times are less dependent on the initial and final gray shades as compared to other addressing techniques for driving matrix LCD is reported. We also found that the response times are about the same as that of a pixel driven with simple square waveforms and therefore the effect of duty cycle due to matrix addressing is minimal with distributed waveforms of this technique.

### CROSS REFERENCE

This application claims a benefit of Indian Patent Application No. 00636/CHE/2009, filed Mar. 20, 2009, the contents of which are herein incorporated by reference.

### TECHNICAL FIELD

Present invention relates to grayscale to grayscale response times in liquid crystal displays (LCDs) i.e. the time taken to switch pixels from one gray shade to another. Response time depends on several factors; viz. liquid crystal mixture, thickness of display cell, electro-optic effect, waveform across pixel etc. Color purity of pixels can be preserved and motion related artifacts can be reduced if RGB sub-pixels in displays switch at the same rate; i.e., if switching times are independent of initial and final gray shades. Waveform (sequence of instantaneous voltages) across a pixel plays an important role in determining its response times. Main objective of this work is to achieve uniform switching times with multi-line addressing techniques like discrete cosine transform, Haar functions, Walsh functions and wavelets based techniques that are capable of displaying a large number of gray shades without flicker.

### BACKGROUND

Liquid crystal displays exhibit RMS (root-mean-square) response when the period of addressing waveforms is small as compared to response times of the display. However, response of liquid crystal molecules to transitions in the addressing waveform can be seen even though they are slow to respond; especially when amplitude of transitions across pixel is large. We studied the effect of scanning sequence (i.e., waveform) on response time. Scope to vary the scanning sequence is limited for line-by-line addressing techniques. On the other hand, multi-line addressing techniques have high flexibility and it is possible to achieve the desired RMS voltages across pixels with different waveforms depending on the choice of scanning sequence i.e., the order of selecting address lines with multiple select pulses of the addressing waveforms.

### REFERENCES

[1] J. E. Bigelow, R. A. Kashnow and C. R. Stein, Contrast optimization in matrix addressed liquid crystal displays, IEEE trans. on Electron Devices, vol. 22, pp 22-24, January 1975.
[2] P. F. Robusto and L. T. Lipton, Multiplexing and contrast optimization for matrix addressed liquid crystal displays, IEEE trans. on Electron Devices, Vol. ED-23, pp 1344-1345, December 1976.
[3] Igarashi, Youichi; Yamamoto, T.; Tanaka, Y.; Someya, J.; Nakakura, Y.; Yamakawa, M.; Nishida, Y.; Kurita, T., ‘Summary of moving picture response time (MPRT) and features’, SID Symposium Digest of Technical Papers; SID Symposium Digest 2004, Volume 35 pp 1262-1265, 2004.
[4] T. N. Ruckmongathan, A generalized addressing technique for RMS responding matrix LCDs, Proc. International Display Research Conference, pp 80-85, 1988.
[5] T. N. Ruckmongathan, Novel addressing methods for fast responding LCDs, Asahi garasu kenkyu hokoku, Vol.43, No. 1, 65-87, 1993.
[6] Scheffer T J; Clifton B, Active addressing method for high-contrast video-rate STN Displays, SID 92 Digest of technical papers, pp 228-231, 1992.
[7] T. N. Ruckmongathan, Nanditha Rao P and Ankita Prasad, Wavelets for Displaying Gray Shades in LCDs, SID Int. Symposium, Digest of technical papers, pp 168-171, 2005.
[8] T. N. Ruckmongathan, U. Manasa, R. Nethravathi and A. R. Shashidhara, Integer Wavelets for Displaying Gray Shades in RMS Responding Displays, IEEE/OSA Journal of Display Technology, Vol. 2, No. 3, pp 292-299, September 2006.
[9] T. N. Ruckmongathan, Deepa S Nadig and P. R. Ranjitha, Gray Shades in RMS Responding Displays With Wavelets Based on the Slant Transform, IEEE transactions on Electron Devices, Vol.54, No.4, pp 663-670, April 2007.
[10] A. R. Shashidhara and T. N. Ruckmongathan, Design and Implementation of the Wavelet based Addressing Technique (WAT), Journal of the Society for Information Display, Vol. 15, No. 3, pp 213-223, 2007.
[11] T. N. Ruckmongathan, Addressing techniques for RMS responding LCDs—A review, Proc. Japan Display '92, pp 77-80, 1992.
[12] Sowmya Gopalan and Temkar. N. Ruckmongathan, Modified discrete cosine transform for addressing liquid crystal displays, Society for Information Display 2008 Symposium Digest of technical papers, Vol. XXXIX, Book. 3, pp 1877-1880, 2008.
[13] Ahmed N and K. R. Rao, Orthogonal transforms for digital signal processing, Berlin, Springer-Verlag, 1975, pp. 169-171.
[14] N. Ahmed, T. Natarajan and K. R. Rao, Discrete cosine transforms, IEEE trans. On Computers vol. -23, No.1, pp 90-93, 1974.
[15] N. A. Lawrence, T. D. Wilkinson and W. A. Crossland, “Combined image decompression and display driving using wavelets based multiple line addressing”, SID 01 Digest, proceeding of SID symposium 2001, pp 98-101, 2001
[16] K. E. Kuijk, “Combining passive and active matrix addressing of LCDs”, Journal of the SID, Vol. 4 No. 1, pp 9-17, 1996.
[17] K. Seikya, H. Nakamura, “Overdrive method for TN-mode LCDs recursive systems with capacitive predictions”, L9.1, SID01 Digest, ISSN/0001-0966/X/3201-0114, proceeding of SID symposium 2001, pp 114-117, 2001.
[18] A. R. Conner and T. J. Scheffer, “Pulse height modulation gray shading methods for passive matrix LCDs”, Proc. 12^{th} International Display Research Conference, 69 (1992).
[19] T. N. Ruckmongathan, A Successive Approximation Technique for Displaying Gray Shades in Liquid Crystal Displays (LCDs), IEEE transactions on Image Processing, Vol. 16, No. 2, pp 554-561, February 2007.
[20] K. G. Pani Kumar and T. N. Ruckmongathan, Displaying Gray Shades in Passive Matrix LCDs using Successive Approximation, Proceedings of the 7^{th} Asian Symposium on Information Display (ASID2002), pp 229-232, Sep. 2-4, 2002.
[21] A. R. Shashidhara and T. N. Ruckmongathan, “Low power LCD with low supply voltage”, Proceedings of international Display Workshop (IDW'08), pp 463-466, December 2008.

### SUMMARY

Accordingly, the present invention provides a method to obtain uniform gray scale to gray scale response times in Liquid Crystal Displays (LCD) by using predetermined select sequences in multiline addressing, said method comprising acts of: selecting predetermined transform based on gray shade data bits to form an orthogonal matrix wherein each column in the matrix is select vector and each row is an orthogonal function; grouping of scanning electrodes of LCD, said group consisting of predetermined number of rows; generating and applying voltages for data electrodes in the group and applying voltages that are proportional to elements of the select vector to the scanning electrodes of the matrix display; rotating rows of the orthogonal matrix and choosing the corresponding data bit of the gray shade once, followed by repeating step ‘c’ until every element in the orthogonal matrix is used to select every row in the group; and repeating step-c and d for every group in the LCD display; and the present invention also provides a system to obtain uniform gray scale to gray scale time response in Liquid Crystal Displays (LCD) by multiline addressing comprising: a matrix liquid crystal display (LCD) to display image; a row driver to drive the rows of the matrix LCD with row waveform; a column driver to drive the columns of the matrix LCD with column waveform; a voltage level generator to facilitate the row driver and the column to generate desired waveforms, and a controller to control the system for multiline addressing.

### BRIEF DESCRIPTION OF DRAWINGS

FIG. 1 show select and data waveforms that are based on MDCT for displaying eight gray shades in RMS responding displays are shown in the figure. (a) to (c) are select waveforms obtained by modifying the DCT; energies of these waveforms are in the ratio 4:2:1. Data waveforms for the grayscales (000) to (111) are (e) to (i) in the figure. Note that waveforms (l),(k),(j) and (i) can be obtained by multiplying the waveforms (e), (f), (g) and (h) respectively with −1 because the respective gray shade bits are compliment of each other.

FIG. 2 shows typical waveforms when MDCT is used to scan the display and select pulses are clustered.

FIG. 3 shows addressing waveforms when select pulses are distributed (separated by at least seven time intervals from each other). Row waveform appears at the top and it is followed by column waveform. Waveform across a pixel a pixel (third waveform) is the difference of the first and the second waveforms.

FIG. 4 shows light transmission through a pixel when the RMS voltage across a pixel is varied to display 8 gray shades with MDCT. Switching time (response time) is about three cycles and it is independent of initial and final gray shade.

FIG. 5 shows number of occurrences vs. percentage deviation from the mean response time (in milliseconds) when pixels are switched from one gray shade to another of a pixel driven by (a) MDCT with distributed waveforms when 3 rows are selected simultaneously (b) with square waveforms (c) MDCT with clustered waveform 3-rows are selected simultaneously (d) MDCT with two rows selected simultaneously (e) line-by-line addressing technique that is based on MDCT and (f) amplitude modulation technique [4].

FIG. 6 shows transmission of light through a pixel in a matrix LCD when the pixel is switched from one gray shade to another. Intensity of light falling on the detector to some extent follows the instantaneous voltage across the pixel; whereas the average light throughput depends on the RMS voltage.

FIG. 7 shows transmission of light through a pixel that is captured using a digital storage oscilloscope and the plot of response time after filtering (moving average of data captured during 20 ms) is shown as a line.

FIG. 8 shows transmission of light through a pixel (above signal) when it is switched from one gray shade to another by using 32-select pulses that are clustered (below signal).

FIG. 9 shows transmission of light through a pixel (above signal) when the scanning sequence is chosen to distribute all the select pulses in the addressing waveform (below signal).

FIG. 10(a) shows number of occurrences of response time vs response time in ms when the scanning sequence has 32-select pulses clustered for wavelets.

FIG. 10(b) shows number of occurrences of response time vs. response time in ms when 4 select pulses i.e., elements of a column of a select vector are clustered and such clusters are separated by 28 time intervals of non-select voltage for LCDs using wavelets.

FIG. 10(c) shows number of occurrences of response time vs. response time in ms when the cluster of scanning pulses is obtained with 2-select vectors wherein clusters are separated by 56 non-select time intervals for LCDs using wavelets.

FIG. 10(d) shows number of occurrences of response times when four select vectors and their rotated version are used to obtain the clustering of select pulses that are separated by applying non-select voltage during 112 time intervals for LCDs using wavelets.

FIG. 10(e) shows number of occurrences of response time vs. response time when rows are selected with the orthogonal matrix with 3 rows obtained by eliminating the zeros in (1). Here row waveforms have clusters of 12 select pulses for LCDs using wavelets.

FIG. 10(f) shows number of occurrences of response times vs. response times for successive approximation technique based on line-by-line addressing for LCDs using wavelets.

FIG. 11 shows photograph of the prototype that can display eight gray shades.

FIG. 12 shows three 2:1 multiplexers select 3-of-6 voltages as inputs to the standard driver. The row driver selects from 8 voltages at any time instant but the selection is made from a total of 11 voltages at all times.

FIG. 13 shows drivers that are capable of applying 1-8 voltages are used along with eight 2:1 analog multiplexers to generate and apply column (data) waveforms.

FIG. 14 shows RMS voltage across pixel vs. supply voltage.

### DETAILED DESCRIPTION

The primary embodiment of the present invention is a method to obtain uniform gray scale to gray scale response times in Liquid Crystal Displays (LCD) by using appropriate select sequences in multiline addressing, said method comprising acts of: selecting predetermined transform based on gray shade data bits to form an orthogonal matrix wherein each column in the matrix is select vector and each row is an orthogonal function; grouping of scanning electrodes of LCD, said group consisting of predetermined number of rows; generating and applying voltages for data electrodes in the group and applying voltages that are proportional to elements of the select vector to the scanning electrodes of the matrix display; rotating rows of the orthogonal matrix and choosing the corresponding data bit of the gray shade once, followed by repeating step ‘c’ until every element in the orthogonal matrix is used to select every row in the group; and repeating step-c and d for every group in the LCD display.

In yet another embodiment the transform used to form modified orthogonal matrix is from a group comprising discrete cosine transforms (DCT), wavelets, Haar functions, Walsh functions.

In still another embodiment rows of the LCD display other than the selected group of rows are maintained at ground potential.

In still another embodiment number of voltages in the select waveform and the column waveform determines amount of gray shades of the display matrix.

In still another embodiment the amount of gray shades increases with increase in the number of voltages in the row waveform and the column waveform.

In still another embodiment the data bits is assigned with values ‘+1’ and ‘−1’ when the bit is logical ‘0’ and ‘1’ respectively.

In still another embodiment the rows of the matrix LCD display are DC free.

In still another embodiment the energy delivered to pixel of the LCD display is proportional to gray shade bit.

Another embodiment of the present invention is a system to obtain uniform gray scale to gray scale time response in Liquid Crystal Displays (LCD) by multiline addressing comprising: a matrix liquid crystal display (LCD) to display image; a row driver to drive the rows of the matrix LCD with row waveform; a column driver to drive the columns of the matrix LCD with column waveform; a voltage level generator to facilitate the row driver and the column to generate desired waveforms, and a controller to control the system for multiline addressing.

In yet another embodiment of the present invention the row drivers select a final voltage from the group of input voltages to drive rows of the display.

In still another embodiment of the present invention the column drivers select a final voltage from the group of input voltages to drive columns of the display.

In still another embodiment of the present invention the row and column driver comprises of shift registers and latches to select the final voltage.

In still another embodiment of the present invention the voltage selectors are preferably analog multiplexers.

In still another embodiment of the present invention the row voltage selectors and the column voltage selectors are common to the entire row drivers and column drivers respectively.

In still another embodiment of the present invention the controller sends control signals to the voltage selectors and the drivers to scan the display.

In still another embodiment of the present invention the controller comprises of counters to generate address of pixels.

Passive matrix type liquid crystal display (LCD) are used in cell phones, MP3 players and other portable gadgets because they have simple structure and cost less as compared to active matrix displays with a thin film transistor (non-linear element) embedded in each pixel. LCD exhibit root-mean square (RMS) response to the electric field when the period of addressing waveforms is smaller than the time taken by liquid crystal molecules to respond and orient to the time variant electric field. Pixels in each row of a matrix display are connected together to a row address line (scanning line) so that they can be selected simultaneously with a select pulse or a waveform. Similarly, a column address line (data line) connects all the pixels in that column to multiplex data assigned to the state of pixels in that column. Hence, each pixel in a matrix display can be uniquely addressed with a scanning line and a data line. Scanning waveforms are equivalent to “carriers” and the data waveforms are equivalent to “multiplexed signal” in a communication system. Orthogonal functions are used to multiplex and de-multiplex the state of pixels in all the addressing techniques for driving passive matrix displays [1]-[11].

Intrinsic non-linear electro-optic characteristic of LCD is useful to de-multiplex or decode the multiplexed signal. Amplitude of scanning and data waveforms is optimized to obtain good contrast in the display [1]-[2]. Response times depend on the liquid crystal mixture, cell gap (thickness of the liquid crystal layer in the display), waveform across the pixel as well as the initial and final grayscales [3]. Rectangular block pulses [1], [2] Rademacher functions [4], Hadamard matrices [5], Walsh functions [6], and wavelets [7]-[10] are used to drive passive matrix displays. Response times have a wide range depending on the initial and final gray shades in displays driven with most of the addressing techniques [8]-[11].

Discrete cosine transform (DCT) is well known for its high-energy compaction ratio and the possibility of using DCT to drive matrix LCD has been demonstrated [12]. We have used discrete cosine transform (DCT) with some minor modification to drive matrix LCD and the gray scale to gray scale response times are more uniform as compared to any other addressing technique to date. Hence, fast moving objects can be displayed with less visual artifacts because all pixels will switch more or less simultaneously during transitions from one frame to another. Similarly, color purity will be better when the color sub-pixels switch simultaneously.

### Discrete Cosine Transform

Discrete cosine transform is a subset of discrete Fourier transform. A function is expressed as a sum of cosine functions of several frequencies in discrete cosine transform (DCT) as compared to using sine and cosine functions of several frequencies in discrete Fourier transform (DFT). A DCT of a signal s(n) is obtained as follows:

$$CT ( k ) = c ( k ) {\sum }_{n = 0}^{N - 1} s ( n ) Cos ( \frac{π ( 2 n + 1 ) k}{2 N} ) \\ Wherein \text{:} c ( 0 ) = \sqrt{\frac{1}{N}} and c ( k ) = \sqrt{\frac{2}{N}} for 1 \leq k \leq N - 1. \qquad ( 1 )$$

DCT can also be represented in to a matrix; an orthogonal matrix of order 4 that is based on the expression in (1) is shown in the following equation.

$$\frac{2}{\sqrt{4}} [ \begin{matrix}\frac{1}{2} & \frac{1}{2} & \frac{1}{2} & \frac{1}{2} \\ 0.9238 & 0.3827 & - 0.3827 & - 0.9238 \\ 0.7071 & - 0.7071 & - 0.7071 & 0.7071 \\ 0.3827 & - 0.9238 & 0.9238 & - 0.3827\end{matrix} ] \qquad ( 2 )$$

The technique is demonstrated by displaying 8 gray shades and it is adequate to have three discrete functions to multiplex the three bits of gray shades that are necessary to represent the 8 gray shades. Although any 3 of the 4 rows of the orthogonal matrix in equation (2) could be used to multiplex the three bits; we have chosen the last 3 rows since they are DC free. Hence, a DC free operation can be achieved within a scan i.e., 4N time intervals instead of 8N time intervals that will be necessary if the 1^{st} row is used for scanning the display. A 3×4 orthogonal matrix that is a subset of the DCT matrix of order 4 is shown in equation 3.

$$[ \begin{matrix}0.9238 & 0.3827 & - 0.3827 & - 0.9238 \\ 0.7071 & - 0.7071 & - 0.7071 & 0.7071 \\ 0.3827 & - 0.9238 & 0.9238 & - 0.3827\end{matrix} ] \qquad ( 3 )$$

Rows of the orthogonal matrix are suitably scaled so that the energies of the corresponding waveforms correspond to the bit weight of the gray shade data. The modified orthogonal matrix is given by

$$[ \begin{matrix}1 & - 1 & - 1 & 1 \\ 0.9238 & 0.3827 & - 0.3827 & - 0.9238 \\ 0.2706 & - 0.6532 & 0.6532 & - 0.2706\end{matrix} ] . \qquad ( 4 )$$

Here, the energy of the waveform corresponding to the first row is

1²+(−1)²+(−1)²+1²=4. (5)

Similarly, the energy of the waveforms corresponding to the second and the third rows are as follows:

2(0.9238)²+2(0.3827)²=2 (6)

2(0.2706)²+2(−0.6532²)=1 (7)

The waveform corresponding to the first row is used to multiplex the most significant bit because it has the highest energy. Waveforms corresponding to rows 2 and 3 are used to multiplex the next significant bit and the least significant bit respectively.

The gray shade bits are assigned either +1 or −1 depending on the logic value of the bit as shown in equation (4).

$${d}_{k , i , j} = \{ \begin{matrix}+ 1 & ∀ & Logic - 0 \\ - 1 & ∀ & Logic - 1\end{matrix} \} \qquad ( 8 )$$

### Technique and Analysis:

The set of orthogonal Chebyshev polynomials Γₖ(m), form the basis vector elements of DCT [12].

$${Γ}_{k} ( m ) = \sqrt{\frac{2}{M}} \cdot cos \frac{( 2 m + 1 ) \cdot k \cdot π}{2 M} ; \\ \{ \begin{matrix}for k = 1 , 2 , … , ( M - 1 ) and \\ m = 0 , 1 , … , ( M - 1 ) .\end{matrix} \qquad ( 9 )$$

Discrete cosine transform [11] of a discrete data sequence X(m); m=0,1, . . . (M−1) is defined [13], [14] as follows:

$${G}_{x} ( k ) = \sqrt{\frac{2}{M}} {\sum }_{m = 0}^{M - 1} X ( m ) \cdot cos ( \frac{( 2 \cdot m + 1 ) \cdot k \cdot π}{2 M} ) \\ wherein \text{:} m = 0 , 1 , … , ( M - 1 ) and k = 1 , 2 , … , ( M - 1 ) \qquad ( 10 )$$

Amplitude of each polynomial Γₖ(m) is multiplied by (\sqrt{2})^{(k-1)} so that the energy of each function is proportional to the weight of a grayscale bit (bit-k) of pixels in a matrix display. The modified polynomials also satisfy the orthogonal condition as shown in (11).

$${\sum }_{m = 0}^{M - 1} {( \sqrt{2} )}^{( k - 1 )} {Γ}_{k} ( m ) {( \sqrt{2} )}^{( l - 1 )} {Γ}_{l} ( m ) = \{ \begin{matrix}{2}^{( k - 1 )} & for k = l \\ 0 & for k \neq l\end{matrix} \qquad ( 11 )$$

Let us consider a matrix display with N rows and arbitrary number of column. Each column is independent of the other if we multiplex the information through column address lines. Let the rows: (i+1), (i+2), . . . ,(i+M−1) be selected simultaneously with (M−1) waveforms of (12).

xᵢ₊ₖ(m)=Vᵣ(\sqrt{2})^{k-1}Γₖ(m); k=1,2, . . . , (M−1) (12)

The remaining (N−M+1) non-selected rows in the matrix display are connected to ground potential i.e. (Vᵣ=0). Let d_{k,i+k}; k=1,2, . . . ,(M−1) be the grayscale bit of pixels that are located at the intersection of selected rows and column “j” and let the data assigned to them be d_{k,i+k}=+1 for ‘logic-0’ and d_{k,i+k}=−1 for ‘logic-1’. Select waveform of row: (i+k) is multiplied with data assigned to the bit-k of a pixel in row (i+k) and (M+1) such products are added to obtain the column (data) waveforms as shown in (13).

$${y}_{j} ( m ) = {V}_{c} {\sum }_{k = 1}^{M - 1} {{d}_{k , ( i + k )} ( \sqrt{2} )}^{( k - 1 )} {Γ}_{k} ( m ) \qquad ( 13 )$$

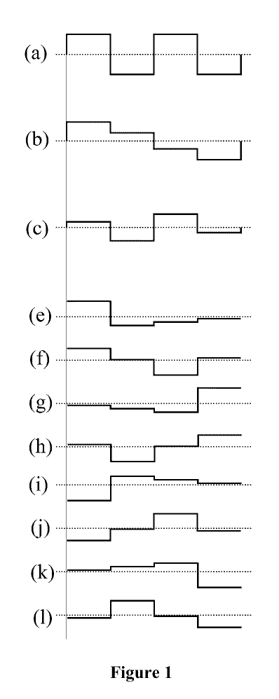

Here, the least significant bit (LSB) is used for the row: (i+1) and the most significant bit is used for the row: (i+M−1) and the intermediate bits for the (M−3) selected rows. It is equivalent to modified discrete cosine transform (MDCT) of just one bit of gray shade of pixels in the selected rows. The terms Vᵣ and V_{c} are used to control the amplitude of row and column waveforms respectively to achieve good contrast in the display. Both the row and column waveforms are applied to the matrix display and information in the multiplexed column waveform is decoded using the intrinsic non-linear characteristics of RMS responding devices like LCD. Typical waveforms when 3-rows are selected simultaneously to display 8-grayscales are shown in FIG. 1. Let the duration of each time interval be T. Waveform across the pixel is the difference of (12) and (13) and energy delivered during M-time intervals to a pixel located at the intersection of row: i+l and a column is:

$${E}_{l , i + l} ( m ) = T {\sum }_{m = 0}^{M - 1} {( \begin{matrix}{{V}_{r} ( \sqrt{2} )}^{l - 1} {Γ}_{l} ( m ) - \\ {V}_{c} {\sum }_{k = 1}^{( M - 1 )} {( \sqrt{2} )}^{k - 1} {Γ}_{k} ( m ) {d}_{k , i + k}\end{matrix} )}^{2} \qquad ( 14 )$$

Orthogonal property of select waveforms is used to simplify the expression to:

E_{l,i+l}(m)=T(Vᵣ²2^{(l-1})−2^{l}VᵣV_{c}d_{l,i+l}+V_{c}²(2^{M-1}−1)) (15)

The second term in (15) depends on the grayscale bit; whereas the first and last terms are independent of the data bit. Hence the energy delivered to the pixel during the M time intervals is proportional gray shade bit. The constant term of (15) will not affect de-multiplexing because it is possible to accumulate some voltage even across an OFF pixel. Electro-optic response of liquid crystal displays has a threshold voltage and the pixels will not respond voltages below the threshold voltage. Waveforms applied to columns will appear across pixels in non-selected rows that are connected to the ground potential because it is not possible to isolate non-selected pixels in passive matrix LCD due to its simple structure. Energy delivered to a pixel if it is not selected during M-time intervals can be obtained by substituting Vᵣ=0 as follows:

$${E}_{n\_s} = {T ( {V}_{c} {\sum }_{k = 1}^{M - 1} {( \sqrt{2} )}^{( k - 1 )} {Γ}_{k} ( m ) {d}_{k , i + k} )}^{2} = T ( {2}^{( M - 1 )} - 1 ) {V}_{c}^{2} \qquad ( 16 )$$

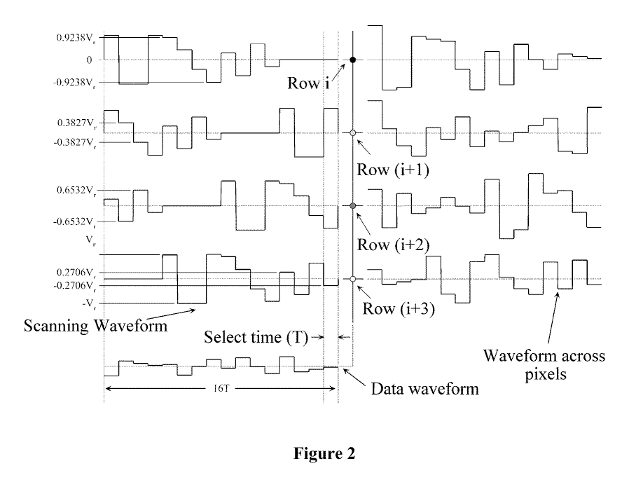

Energy delivered to the non-selected pixels is independent of the data bits because the value assigned to the bits is (±1) i.e. the magnitude of the voltages is same. It is clear from the expression in (17) that a cross talk free display can be achieved when MDCT is used for addressing LCD because the energy delivered to the non-selected pixels is independent of state of the pixels in the selected row(s). An address cycle gets completed when N rows in the matrix display are selected with (M−1) -select waveforms once, i.e. when each row is selected with waveforms x_{i|k}(m); k=1,2, . . . ,(M−1). The address duty cycle is higher by a factor (M−1) as compared to that of the line-by-line addressing. Typical addressing waveforms are shown in FIG. 2. It is not necessary that N should be an integral multiple of (M−1). In case N, the number of address lines is not an integral multiple of (M−1) then the following scheme can be adopted. Let rows (i+1) wherein l=1, 2, . . . ,(M−1) be selected with waveforms that are proportional to (\sqrt{2})^{(l-1)}Γₗ(m) for M time intervals. Then the select waveforms are shifted by one row so that rows (i+1+l) where in l=1, 2, . . . ,(M−1) are selected with waveforms that are proportional to: (\sqrt{2})^{(l-1)}Γₗ(m) during M-time intervals. An address cycle consists of N such shifts and the total duration is (M.N) time intervals and each row is selected during (M−1).M time intervals. Energy delivered to the pixel during (M−1)·M-time intervals when the corresponding row is selected with (M−1) discrete cosine functions is obtained by adding the energy corresponding to each of the grayscale bit.

$$\begin{matrix}{E}_{i , j\_s} = {\sum }_{l = 1}^{M - 1} {E}_{l , i} ( m ) \\ = {\sum }_{l = 1}^{M - 1} ( {2}^{( l - 1 )} {V}_{r}^{2} - {2}^{l} {V}_{r} {V}_{c} {d}_{l , i} + ( {2}^{( M - 1 )} - 1 ) {V}_{c}^{2} ) & ( 17 ) \\ {E}_{i , j\_s} = ( {2}^{( M - 1 )} - 1 ) ( {V}_{r}^{2} + ( M - 1 ) \cdot {V}_{c}^{2} ) - {\sum }_{l = 1}^{M - 1} {2}^{l} {d}_{l , i} {V}_{r} {V}_{c} & ( 18 )\end{matrix}$$

Similarly, energy delivered to the pixel in row-i during

$$M ( \frac{N}{( M - 1 )} - 1 )$$

time intervals when the corresponding row is not selected is obtained as shown in (19) and (20).

$$\begin{matrix}{E}_{i , j\_ns} = ( \frac{N}{( M - 1 )} - 1 ) {\sum }_{m = 0}^{M - 1} {( {V}_{c} {\sum }_{k = 1}^{M - 1} {{d}_{k , i + k} ( \sqrt{2} )}^{( k - 1 )} {Γ}_{k} ( m ) )}^{2} & ( 19 ) \\ \begin{matrix}{E}_{i , j\_ns} = {V}_{c}^{2} ( \frac{N}{M - 1} - 1 ) {\sum }_{k = 1}^{M - 1} ( {2}^{( M - 1 )} - 1 ) \\ = {V}_{c}^{2} ( \frac{N}{M - 1} - 1 ) ( M - 1 ) ( {2}^{( M - 1 )} - 1 )\end{matrix} & ( 20 )\end{matrix}$$

Hence, energy delivered to a pixel when it is not selected is independent of the data of the selected pixels. RMS voltage across the pixel is given by:

$$\begin{matrix}{V}_{pixel} ( RMS ) = \sqrt{\frac{{E}_{i , j\_s} + {E}_{i , j\_ns}}{M \cdot N}} & ( 21 ) \\ {V}_{pixel} ( RMS ) = \sqrt{\frac{( {2}^{( M - 1 )} - 1 ) ( {V}_{r}^{2} + {NV}_{c}^{2} ) - {\sum }_{l = 1}^{M - 1} {2}^{k} {d}_{l , i} {V}_{r} {V}_{c}}{MN}} & ( 22 )\end{matrix}$$

RMS voltage across a pixel when d_{k-1,j}=+1 ∀ k=1,2 . . . ,(M−1) i.e. an OFF pixel is:

$${V}_{OFF} ( RMS ) = \sqrt{\frac{( {2}^{M - 1} - 1 ) ( {V}_{r}^{2} - 2 {V}_{r} {V}_{c} + {NV}_{c}^{2} )}{MN}} \qquad ( 23 )$$

Similarly, RMS voltage across a pixel when d_{k 1,j}=−1 ∀ k=1,2 . . . ,(M−1) is as follows.

$${V}_{ON} ( RMS ) = \sqrt{\frac{( {2}^{M - 1} - 1 ) ( {V}_{r}^{2} + 2 {V}_{r} {V}_{c} + {NV}_{c}^{2} )}{MN}} \qquad ( 24 )$$

The selection ratio, ratio of the RMS voltages across the ON pixel to that of the OFF pixel in this technique is a maximum when Vᵣ=\sqrt{N}.V_{c} and it is same as the maximum achievable by any addressing technique [11], [12].

$$\frac{{V}_{ON} ( RMS )}{{V}_{OFF} ( RMS )} = \sqrt{\frac{\sqrt{N} + 1}{\sqrt{N} - 1}} \qquad ( 25 )$$

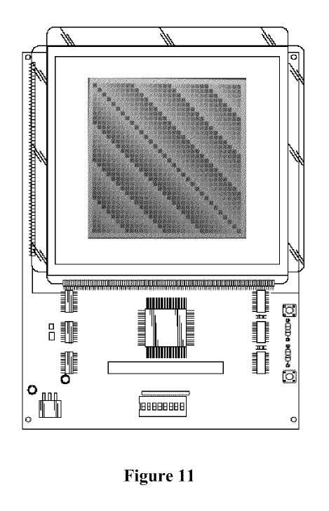

The technique was demonstrated by displaying eight gray shades [12]. A photograph of a display system is shown in FIG. 11. The driver circuit of passive matrix LCD consists of row driver circuit, column driver circuit, voltage level generator and the controller. Both row and column drivers have analog multiplexers that select voltages to be applied to the matrix display. The controller is implemented in a CPLD (complex programmable logic device). The modified DCT matrix for multiplexing 3-bits is as follows:

$$[ \begin{matrix}1 & - 1 & - 1 & 1 \\ 0.924 & 0.383 & - 0.383 & - 0.924 \\ 0.271 & - 0.653 & 0.653 & - 0.271\end{matrix} ]$$

The MDCT for the finite set of data are computed during the design stage and programmed into the VLG (voltage level generator; a resistor network) and therefore it is not necessary to compute the MDCT while scanning the display. Row waveforms have 11 voltages and drivers that are capable of applying 1 of the 11 voltages to the 32 rows are necessary for direct implementation of the driver circuit. However, drivers that are capable of applying 1-out-of-4 voltages are adequate when four 4:1 analog multiplexers are used to feed voltages corresponding to select vectors to the 32 stages of the row drivers because just three select voltages and a non-select voltage are applied to the matrix display at a given instant of time. We have used “off-the-shelf” row drivers that are capable of applying any one of eight voltages along with three 2:1 analog multiplexers that are common to all 32 stages of the row driver board as shown in the FIG. 8. Similarly, display drivers that are capable of applying one-out of eight voltages is used as column drivers along with eight numbers of 2:1 analog multiplexers to apply any one of the sixteen voltages because at a given instant of time just eight voltages need to be applied as shown in the FIG. 9. The eight 2:1 analog multiplexers are common to all the stages of the column drivers. Additional information on hardware implementation of the technique can be found in reference 12.

The display was refreshed at 50 Hz and the minimum frequency to avoid flicker is 40 Hz. The display is not optimized for response time and faster response times may be achieved with other liquid crystal mixtures. Response times were measured by applying row and column waveforms from the prototype to a cell filled with RO-TN-623 Thickness of the cell was 5. 6 μm. The controller in the prototype was programmed to switch the pixel to different gray shades and the change in light transmission through the cell was captured using a photo detector. The output of the photo detector was acquired using a digital storage oscilloscope to measure the response times.

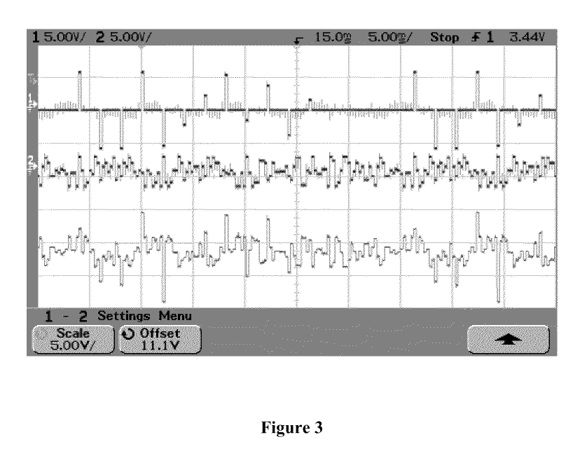

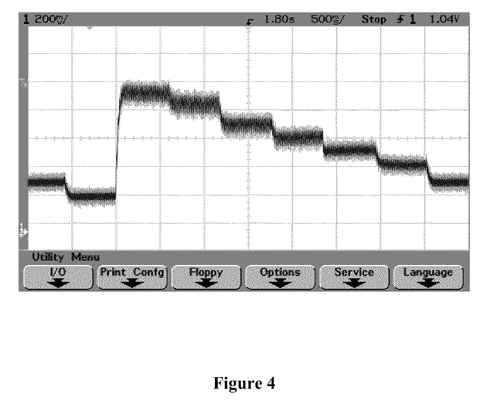

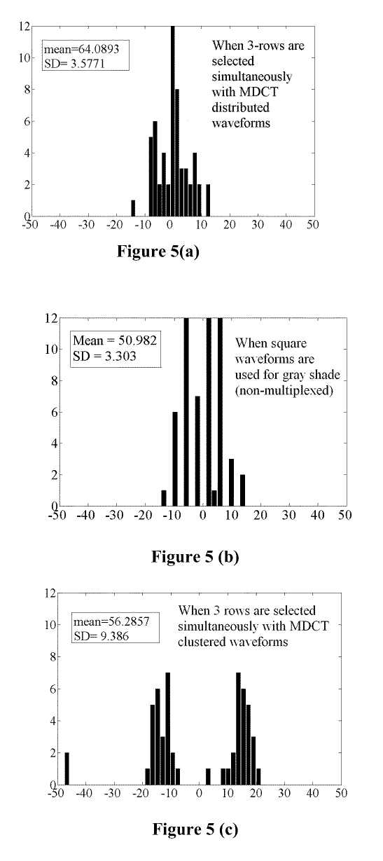

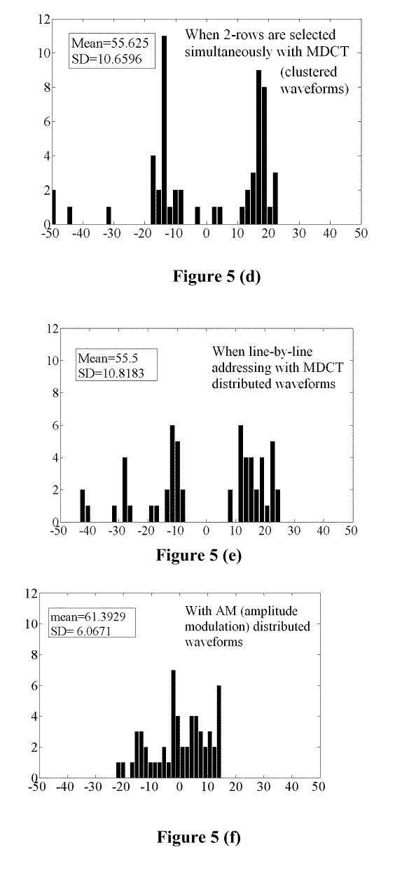

There are several ways to scan the matrix display. A subgroup may be selected with the all the select vectors (columns of the orthogonal matrix) and rotated versions of select vectors before selecting another subgroup leading to clustering of select pulses as shown in FIG. 2. Alternately, each subgroup can be selected with just one select vector and it results in distributed select pulses shown in FIG. 3. It is very useful to suppress the frame response and to eliminate flicker even with relatively low refresh rates as compared to the clustered waveforms. The addressing technique with distributed select pulses of MDCT also achieves uniform response times as shown in FIG. 4. Response times were measured by switching the pixels from one gray to anther with distributed waveforms shown in FIG. 3. Light transmission through a pixel when it is switched from one gray scale to another is shown in FIG. 4. Distribution of response times (28-rise times and equal number of fall times) that were measured is shown in FIG. 5(a). Response times of the same cell for several variants of the technique and amplitude modulation for 8 gray shades are also shown in FIG. 5(c) to (f) for comparison. In order to see the effect of addressing technique on response times; we applied square waveforms (100 Hz) with their RMS voltage equal to that of the eight gray shades in a matrix display with 32 address lines; see FIG. 5(b). Response times measured under this condition were about the same as that obtained when the matrix display is multiplexed with distributed waveforms of MDCT. It is interesting to note that the effect of duty cycle in the addressing waveform is not seen when DCT is used because response times obtained with the addressing waveforms are very close to the response times when pixels are driven with continuous square waveforms (without duty cycle). Hence the response times are not affected by DCT based addressing waveforms. The technique retains the advantages of multi-line addressing viz. higher address duty factor, low supply voltage, and suppression of frame response.

Modified Discrete Cosine Transform has paved way to achieve uniform response times in passive matrix LCD leading to elimination of motion related artifacts and better color purity of images. It is also important to note that the discrete cosine transform is used in compression techniques for static as well as video images as shown by Lawrence et al [15]. Column waveforms of multi-line addressing techniques are proportional to the one-dimensional transform of images and hence hardware and time that are necessary for decoding the compressed images apart from elimination of the column signal generator in the controller of multi-line addressing technique. Aperture available for light transmission in a pixel decreases as we increase the resolution of active matrix LCD due to the space occupied by the thin film transistors at each pixel and driving the display by combining active and passive matrix addressing as proposed by Kuijk et al [16]. Narrow with increased resolution. If ‘s’ is number of lines that are selected simultaneously then the number of thin film transistors can be reduced by a factor s and this approach is very useful for high resolution displays such as medical displays. Relatively large amplitude of the passive addressing waveforms used for selecting s-rows will have the same effect as the waveforms that are modified to improve the response time of active matrix LCD [17]. Pulsed nature of the addressing waveforms in waveforms of passive addressing is useful in achieving uniform response times.

Wavelets based Addressing Technique:

Wavelets based addressing technique can display a large number of gray shades without flicker. Hardware complexity of display drivers and the supply voltage are low for wavelets based multi-line addressing techniques. Wavelets based addressing technique is described briefly with an example. Waveforms derived from an orthogonal matrix shown in (26) are used to display 64 gray shades in matrix LCDs. Wavelets in the 1^{st}, 2^{nd} and 3^{rd} rows are used to deliver energies that are proportional to weight of gray shade bits d₅, d₂ and d₄ respectively; where as a combination of 3-wavelets in 4^{th} row are used to deliver energies that are proportional to bits d₃, d₁ and d₀ respectively. Here, d₅ is the most significant bit and hence, it has eight non-zero elements. Wavelets corresponding to lower bits either have less number of elements (for example row-3) or elements of lower amplitude as in the case of row-2 and to some extent row-4.

$$[ \begin{matrix}+ 4 & - 4 & + 4 & - 4 & + 4 & - 4 & + 4 & - 4 \\ 0 & + 2 & 0 & - 2 & 0 & + 2 & 0 & - 2 \\ + 4 & 0 & - 4 & 0 & + 4 & 0 & - 4 & 0 \\ + 4 & + 1 & - 2 & - 1 & - 4 & - 1 & + 2 & + 1\end{matrix} ] \qquad ( 26 )$$

Bits corresponding to each element of the orthogonal matrix are shown in (27).

$$[ \begin{matrix}{d}_{5} & {d}_{5} & {d}_{5} & {d}_{5} & {d}_{5} & {d}_{5} & {d}_{5} & {d}_{5} \\ 0 & {d}_{2} & 0 & {d}_{2} & 0 & {d}_{2} & 0 & {d}_{2} \\ {d}_{4} & 0 & {d}_{4} & 0 & {d}_{4} & 0 & {d}_{4} & 0 \\ {d}_{3} & {d}_{0} & {d}_{1} & {d}_{0} & {d}_{3} & {d}_{0} & {d}_{1} & {d}_{0}\end{matrix} ] \qquad ( 27 )$$

A cycle of scanning is complete when each and every group of rows in the matrix display is selected with voltages (select pulses) that are proportional to each and every element of the orthogonal matrix in (26). Data waveforms are also applied simultaneously to columns of the matrix display as described in reference 8. Some of the many possible sequences of scanning the matrix display are described in the next section.

### Some Scanning Sequences

Rows in a matrix display are grouped so that each group has a pre determined number of rows (four rows in our example). Columns of the orthogonal matrix are called select vectors because several rows in a matrix display are selected simultaneously by applying voltages that are proportional to the elements of select vector. A scanning cycle consists of selecting each and every group of rows (in the display) with all select vectors in the orthogonal matrix and its rotated versions once; i.e., 32-select vectors in our example. A few possible select sequences are as follows:
Each group is selected sequentially with all the select vectors and their rotated versions once and the groups are also selected sequentially to complete a cycle. The 32-select pulses are clustered together in our example.
Each group is selected with any one select vector and the groups are selected sequentially one after another. A cycle is complete when all the groups are selected once with all the select vectors. Here, all the 32-select pulses are distributed without any clusters.
Each group is selected with a few select vectors and the groups are selected sequentially till all the select vectors are used to select the groups once. Select pulses in the addressing waveforms will be partially clustered and such clustered pulses are also distributed equally in the addressing waveforms.

In yet another approach; each group of rows can be selected with a select vector and its rotated versions before selecting other groups sequentially and a cycle is complete when all the select vectors in the orthogonal matrix is used once to select the groups. Here, there is a possibility of clustering select pulses corresponding to different gray shade bits and avoiding clusters of pulses of same bit in a systematic manner. We have used this scanning sequence to achieve a reasonably uniform gray scale to gray scale response times.

### Measurement of Response Times

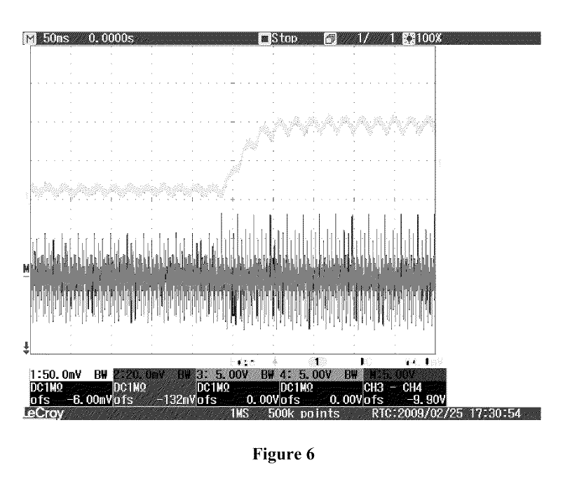

Liquid crystal displays exhibit RMS (root-mean-square) response to the electric field when the period of addressing waveforms is smaller than the time taken by the molecules to reorient to the electric field. Hence, the period of addressing waveforms of passive matrix LCD is chosen to be smaller than the response time of the display to achieve RMS response. Light transmission through a pixel (in a matrix LCD) that was captured using a photo detector and a digital storage oscilloscope is shown in FIG. 6.

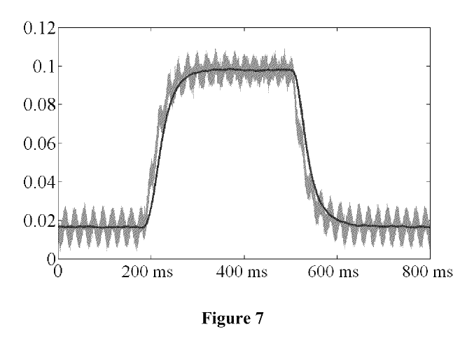

Fluctuations in light transmission seen in the figure are due to response of the liquid crystals to transitions in the addressing waveform. We have used a moving average filter to average the samples of detector output during a period of 20 ms (equal to the period of a frame i.e. time taken to address the display once) to obtain a smooth response curve as shown in FIG. 7. The moving average filter is also useful to eliminate the interference from the power line frequency of 50 Hz. We have used the conventional definition of response time and measured the time taken for the light transmission to change from 10% to 90% of the total change in light transmission from one gray shade to another.

### Effect of Select Sequence

Light transmission through a pixel in two extreme cases of select sequences are shown in FIGS. 8 and 9 respectively when a pixel is driven from one gray scale to another with wavelets based addressing technique.

### Clustered Pulses in Select Waveforms

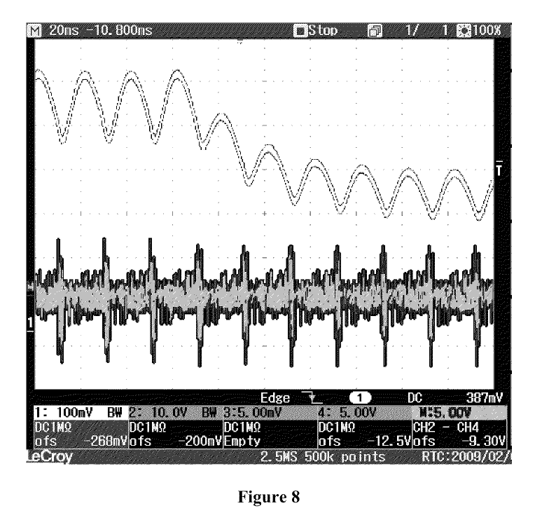

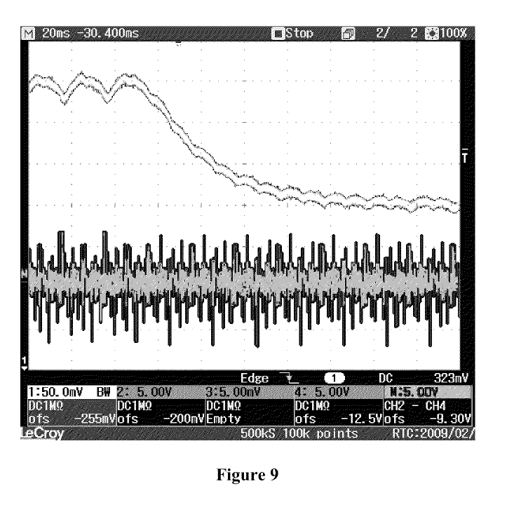

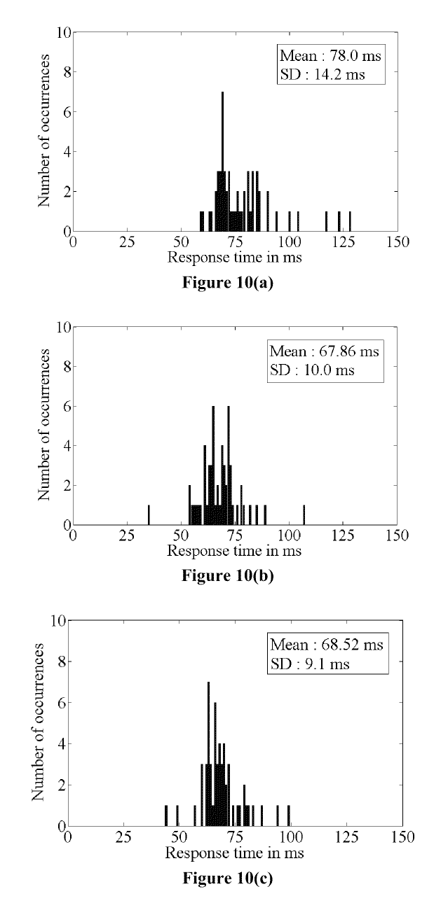

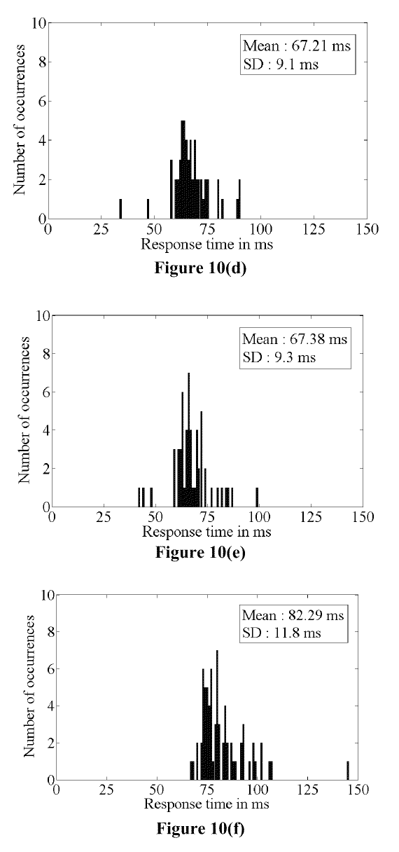

Select pulses corresponding to eight columns of the orthogonal matrix are clustered and subsequent 3-sets of eight pulses are obtained by rotating the matrix vertically to obtain clustered select pulses in the select (row) waveforms. For example; amplitude of select pulses for the first row is as shown here: {4,−4,4,−4,4,−4,4,−4,0,2,0,−2,0,2,0,'12,4,0,−4,0,4,0,−4,0,4,1,−2,−1,−4, −1, 2,1} and the voltage will be 0 (non-select voltage) during 224 time intervals in a cycle of 256 time intervals. Distribution of response times is shown in FIG. 10(a).

Response times range from 59 to 127 ms with a mean of 78 ms and standard deviation of 14.16 ms. Spread in response times is reduced with the select sequences described next.

### Small Cluster of Pulses by Rotation

We found that small cluster of pulses obtained by rotating one or few select vectors that are separated by a relatively long duration of non select voltage, are better way from the point of response times. We have measured the response times when 1, 2 and 4 select vectors and their rotated versions are used to select the address lines. For example; the select pulses are proportional to {4,0,4,4,−4,2,0,1} during 8 time intervals and it is followed by application of non-select for a duration of 56 time intervals when two select vectors are used to get the clustered pulses.

Results of response time measurements are shown in FIGS. 10(b), 10(c) and 10(d) respectively. Response time ranges from 35 to 107 ms with a mean of 68 ms and a standard deviation of about 10 ms when one select vector is used for clustering pulses.

Response times range from 46 to 100 ms with average response time of 68.5 ms and a standard deviation of 9.1 ms when two select vectors were used at a time to obtain the clusters.

Response times range from 34 to 90 ms with an average response time of 67.2 ms and standard deviation of 9 ms when 4 select vectors and their rotated versions are used to get the cluster of select pulses.

The orthogonal matrix in (26) has eight zeros that are introduced to reduce the hardware complexity of the controller. At a given instant of just three rows are selected even though the groups are formed with 4 rows. We have used the following orthogonal matrix with just 3-rows to address the matrix LCD and the result of the measurements is shown in FIG. 10(e).

$$[ \begin{matrix}+ 4 & - 4 & + 4 & - 4 & + 4 & - 4 & + 4 & - 4 \\ + 4 & + 2 & - 4 & - 2 & + 4 & + 2 & - 4 & - 2 \\ + 4 & + 1 & - 2 & - 1 & - 4 & - 1 & + 2 & + 1\end{matrix} ] \qquad ( 28 )$$

Response times range from 42 to 99 ms with a mean of 67.38 ms and a standard deviation of 9.3; which is not very different from the measurements in FIG. 10(d).

### Line-by-Line Addressing—Response Times

For the sake of comparison we have measured the grayscale to grayscale response times when successive approximation technique based on line-by-line addressing⁵ is used to drive the display. Response times range from 67 to 145 ms with a mean of 82 ms and standard deviation of 11.8 as shown in FIG. 10(f). The average response time is high as compared to the wavelets based technique wherein the duty cycle of the addressing is 3-times that of line-by-line. Similarly, the standard deviation of wavelets based addressing is 9 ms as compared to 11.8 of the successive approximation based on line-by-line addressing.

### Multi-Line Addressing—Response Times

Result of response time measurements of multi-line successive approximation technique based on sparse matrix that was presented in IDW'08⁶ is shown here for the sake of comparison. Here, seven rows are selected at a time and the response times range from 45 to 74 ms with a mean of 61.44 ms and a standard deviation of 5.8 ms. All the measurements presented in this paper were performed with TN-LCD having 5.4 μm cell gap filled with RO-TN-623 at 25° C. with a frame frequency of 50 Hz.

### Implementation

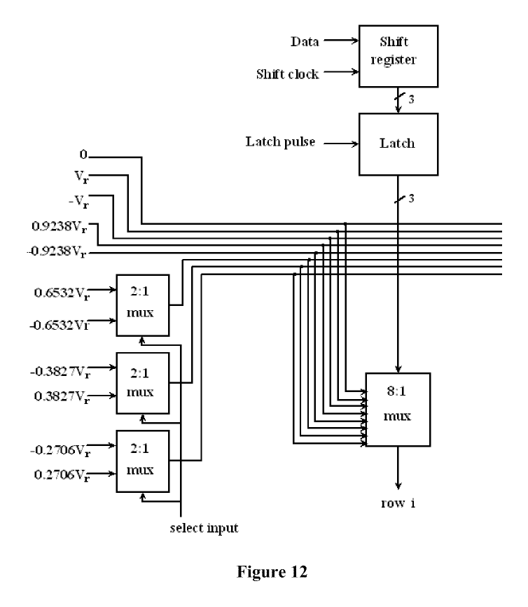

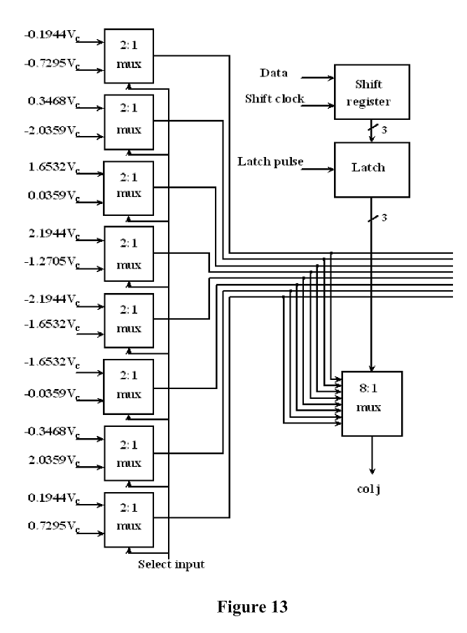

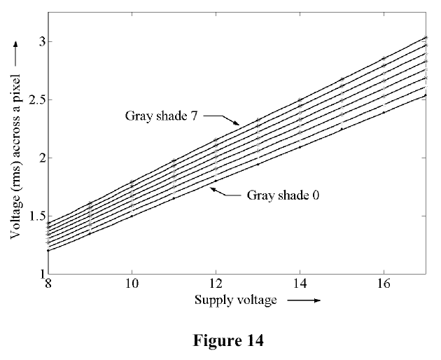

The technique is demonstrated with a 32*32 matrix twisted nematic (TN) LCD. Row waveforms have 11 voltage levels, but it is adequate to have 3-select and a non-select voltage at a time. Drivers that are capable of applying 1-of-4 voltages can be used to for applying the row waveforms. Off the shelf driver that is capable of applying 1-of-8 voltages is used along with some multiplexers as shown in FIG. 12. Just eight voltages out of 16 voltages are necessary at any time and drivers that are capable of selecting 1-of-8 voltages is used along with eight 2:1 analog type multiplexers as shown in FIG. 13. A photograph of the prototype is shown in FIG. 11. Plots of RMS voltage across pixels that are driven to the eight gray shades vs. the supply voltage of the drivers are shown in FIG. 14. Light transmission through the pixel when the pixel is switched from one grayscale to another is shown in the FIG. 4. Grayscale to grayscale response times of the display is shown in Table I. Note that the entries in upper-left triangle in the table are rise times and those in lower-right triangle are the fall times. It is important to note that the switching times of the multiplexed display is almost same as that obtained by driving the pixel with simple square waveforms having same RMS values. Hence, the response times are not affected if the matrix is scanned with the discrete cosine function. Uniform response times will improve the color purity of pixels in color displays and eliminate motion related artifacts in moving images.

TABLE I

| RMS voltages | 1.33 V | 1.37 V | 1.41 V | 1.45 V | 1.48 V | 1.52 V | 1.56 V | 1.59 V |
|---|---|---|---|---|---|---|---|---|
| 1.33 V | x | 68 | 65 (60) | 68 | 64 | 65 (58) | 65 | 67 (53) |
| | | (70) | | (61) | (59) | | (57) | |
| 1.37 V | 68 (70) | X | 67 | 64 | 62 | 62 | 64 | 65 (55) |
| | | | (67) | (59) | (59) | (60) | (54) | |
| 1.41 V | 60 (65) | 66 | X | 60 | 61 (58) | 60 | 62 | 58 (57) |
| | | (69) | | (64) | | (63) | (57) | |
| 1.45 V | 64 (65) | 62 | 64 | X | 60 | 58 | 60 | 60 (56) |
| | | (63) | (66) | | (64) | (60) | (58) | |
| 1.48 V | 63 (64) | 60 | 55 | 60 | X | 56 | 50 | 55 (59) |
| | | (63) | (62) | (65) | | (65) | (57) | |
| 1.52 V | 60 (63) | 60 | 58 | 56 | 60 | X | 60 | 52 (61) |
| | | (60) | (63) | (64) | (64) | | (61) | |
| 1.56 V | 64 (61) | 65 | 60 | 58 | 56 | 62 | X | 55 (58) |
| | | (61) | (61) | (59) | (57) | (61) | | |
| 1.59 V | 68 (60) | 64 | 64 | 62 | 60 | 62 | 56 | X |
| | | (63) | (62) | (61) | (64) | (63) | (56) | |

What is claimed is:

1. A method to obtain uniform gray scale to gray scale response times in Liquid Crystal Displays (LCD) by using predetermined select sequences in multiline addressing, said method comprising acts of:
a. selecting predetermined transform based on gray shade data bits to form orthogonal matrix wherein each column in the matrix is select vector and each row is a orthogonal function;
b. grouping of scanning electrodes of LCD, said group consisting of predetermined number of rows;
c. generating and applying voltages for data electrodes in the group and applying voltages that are proportional to elements of the select vector to the scanning electrodes of the matrix display;
d. rotating rows of the orthogonal matrix and choosing the corresponding data bit of the gray shade data matrix once, followed by repeating step ‘c’ until every element in the orthogonal matrix is used to select every row in the group; and
e. repeating step-c and d for every group in the LCD display.

2. The method as claimed in claim 1, wherein the transform used to form modified orthogonal matrix is from a group comprising discrete cosine transforms (DCT), wavelets, Haar functions, Walsh functions.

3. The method as claimed in claim 1, wherein rows of the LCD display other than the selected group of rows are maintained at ground potential.

4. The method as claimed in claim 1, wherein number of voltages in the select waveform and the column waveform determines amount of gray shades of the display matrix.

5. The method as claimed in claim 1, wherein the amount of gray shades increases with increase in the number of voltages in the row waveform and the column waveform.

6. The method as claimed in claim 1, wherein the data bits is assigned with values ‘+1’ and ‘−1’ when the bit is logical ‘0’ and ‘1’ respectively.

7. The method as claimed in claim 1, wherein the rows of the matrix LCD display are DC free.

8. The method as claimed in claim 1, wherein the energy delivered to pixel of the LCD display is proportional to gray shade bit.

9. A system to obtain uniform gray scale to gray scale time response in Liquid Crystal Displays (LCD) by multiline addressing comprising:
a. a matrix liquid crystal display (LCD) to display image;
b. a row driver to drive the rows of the matrix LCD with row waveform;
c. a column driver to drive the columns of the matrix LCD with column waveform;
d. a voltage level generator to facilitate the row driver and the column to generate desired waveforms, and
e. a controller to control the system for multiline addressing.

10. The system as claimed in claim 9, wherein the row drivers select a final voltage from the group of input voltages to drive rows of the display.

11. The system as claimed in claim 9, wherein the column drivers select a final voltage from the group of input voltages to drive columns of the display.

12. The system as claimed in claim 11, wherein the row and column driver comprises of shift registers and latches to select the final voltage.

13. The system as claimed in claim 9, wherein the voltage selectors are preferably analog multiplexers.

14. The system as claimed in claims 9, wherein the row voltage selectors and the column voltage selectors are common to the entire row drivers and column drivers respectively.

15. The system as claimed in claims 9, wherein the controller sends control signals to the voltage selectors and the drivers to scan the display.

16. The system as claimed in claims 9, wherein the controller comprises of counters to generate address of pixels.
